(19) United States
(12) Patent Application Publication
(10) Pub. No.: US 2014/0004437 A1
(43) Pub. Date: Jan. 2, 2014

(54) STACKED FLOW CELL DESIGN AND METHOD

(71) Applicant: 24M Technologies, Inc., Cambridge, MA (US)

(72) Inventors: Alexander H. Slocum, Bow, NH (US); Ricardo Bazzarella, Woburn, MA (US); William Craig Carter, Jamaica Plain, MA (US); Yet-Ming Chiang, Weston, MA (US); Mihai Duduta, Somerville, MA (US)

(21) Appl. No.: 13/915,309

(22) Filed: Jun. 11, 2013

Related U.S. Application Data
(63) Continuation of application No. PCT/US2011/065623, filed on Dec. 16, 2011.
(60) Provisional application No. 61/424,026, filed on Dec. 16, 2010.

(51) Int. Cl. H01M 8/04

(52) U.S. Cl. CPC H01M 8/04186
USPC 429/443

(57) ABSTRACT

A multi-cell stack electrochemical device having an ion-permeable membrane separating positive and negative current collectors. A plurality of actuating devices configured to inject an electroactive composition into multiple zones within an electrochemical cell. The actuating devices are configured to apply direct pressure to internally contained electroactive composition to displace depleted electroactive material contained within an electrochemical cell. Gravity or mechanical means are used to operate the actuating device to displace electroactive composition that is internally housed.

### FIELD OF THE INVENTION

The present invention generally relates to an electrochemical battery cell. More particularly, the present invention relates to high energy density battery flow cells.

### BACKGROUND

Conventional battery systems store electrochemical energy by separating an on source and on sink at differing ion electrochemical potential. A difference in electrochemical potential produces a voltage difference between the positive and negative electrodes, which produces an electric current if the electrodes are connected by a conductive element. In a conventional battery system, negative electrodes and positive electrodes are connected via a parallel configuration of two conductive elements. The external elements exclusively conduct electrons, however, the internal elements, i.e., electrolytes, exclusively conduct ions. The external and internal flow streams supply ions and electrons at the same rate, as a charge imbalance cannot be sustained between the negative electrode and positive electrode. The produced electric current can be used to drive an external device. A rechargeable battery can be recharged by application of an opposing voltage difference that drives electric and ionic current in an opposite direction as that of a discharging battery. Accordingly, an active material of a rechargeable battery requires the ability to accept and provide ions. Increased electrochemical potentials produce larger voltage differences between the cathode and anode of a battery, which increases the electrochemically stored energy per unit mass of the battery. For high-power batteries, the ionic sources and sinks are connected to a separator by an element with large ionic conductivity, and to the current collectors with high electric conductivity elements.

Redox flow batteries, also known as a flow cells or redox batteries or reversible fuel cells, are energy storage devices in which the positive and negative electrode reactants are soluble metal ions in liquid solution that are oxidized or reduced during the operation of the cell. Using two soluble redox couples, one at the positive electrode and one at the negative electrode, solid-state reactions are avoided. A redox flow cell typically has a power-generating assembly comprising at least an ionically transporting membrane separating the positive and negative electrode reactants (also called cathode slurry and anode slurry, respectively), and positive and negative current collectors (also called electrodes) which facilitate the transfer of electrons to the external circuit but do not participate in the redox reaction (i.e., the current collector materials themselves do not undergo Faradaic activity). Redox flow batteries have been discussed by M. Bartolozzi, “Development of Redox Flow Batteries: A Historical Bibliography,” J. Power Sources, 27, 219 (1989), and by M. Skyllas-Kazacos and F. Grossmith, “Efficient Vanadium Redox Flow Cell,” Journal of the Electrochemical Society, 134, 2950 (1987), and is hereby incorporated by reference.

Differences in terminology for the components of a flow battery and those of conventional primary or secondary batteries are herein noted. The electrode-active solutions in a flow battery are typically referred to as electrolytes, and specifically as the cathode slurry and anode slurry, in contrast to the practice in lithium ion batteries where the electrolyte is solely the ion transport medium and does not undergo Faradaic activity. In a flow battery the non-electrochemically active components at which the redox reactions take place and electrons are transported to or from the external circuit are known as electrodes, whereas in a conventional primary or secondary battery they are known as current collectors.

Semi-solid flow cells (SSFCs) utilize solid particles suspended in fluid electrolytes. The particle suspensions can flow and act as anolytes and catholytes. The electrolyte suspension provides ionic conductivity from the electrochemically active particles to an electrically insulating and ionically conductive particle separator. Inasmuch that electrochemical fuel flows from reservoirs to a power stack, both SSFCs and redox flow batteries share the advantage of separating energy storage to power delivery (in discharge mode) and absorption (in charge mode). SSFCs electrochemical fuel density is higher than that of redox flow batteries, which has the benefit of smaller storage and flow rate requirements in comparison to a redox flow batteries. However, the flowing fluids' viscosity is generally higher that of redox flow batteries which increases their working pressures at comparable flow rates.

While redox flow batteries and semi-solid flow cells have many attractive features, including the fact that they can be built to almost any value of total charge capacity by increasing the size of the cathode slurry and anode slurry reservoirs, one of their limitations is that the slurry is typically moved throughout the cell by use of pumps, e.g., peristaltic pumps. Furthermore, these flow cell batteries typically use other components such as manifolds in order to transport the slurry throughout the cell. The semi-solid anode slurry or cathode slurry are electrically conductive materials. Thus, during operation of the device, shunt current may occur to bypass one or more cell compartments in the device. The occurrence of shunt current from cathode to cathode and anode to anode will decrease the stack voltage. This design has the disadvantage of requiring more components that could require more physical space within a cell, as well as the propensity of failure of the multiple components.

### SUMMARY OF EXEMPLARY EMBODIMENTS OF THE INVENTION

Method and apparatus for eliminating shunt currents in a redox energy storage system are described.

In one aspect, fluid cylinders with a piston and rod (often referred to as a “piston” or “cylinder”) that are actuated by either pneumatic, electric, or gravity force sources are provided in flow communication with a flow cell of a flow cell stack. Actuators move the piston and displace an anode or cathode fluid housed in the cylinder and thus move the fluids through the plates in a redox flow cell without the use of a pump.

Shunt current can be eliminated by using multiple sets of pistons that are configured such that each layer in the stack is serviced by its own unique cathode/anode piston set. Furthermore, this enables use of many small individual components (pistons and actuators) so economies of mass production can be taken advantage of. In addition, should any one piston fail, it is a small incremental contributor to the entire stack, so overall performance will not be seriously degraded. Still further, the output of each piston can be a wide nozzle directly attached to each layer because a long electrically insulating fluid path is not needed to prevent shunt currents, so the fluid resistance from the reservoir to the layer is minimized which helps to greatly reduce flow resistance and thus actuator power. This also makes it practical to operate the stack in a gravity mode where the pistons are weighted and the flow rate and direction through the stack are based on the angular orientation of the stack/piston assembly.

According to an exemplary aspect, a flow cell energy storage system is provided. The system comprises a flow cell with positive and negative current collectors, an ion permeable membrane separating the collectors, positioned to define positive and negative electroactive zones, and a plurality of actuating devices configured to inject positive and negative electroactive composition into the positive or negative zones.

In the preceding embodiment, the membrane is configured to allow ion transfer.

In any of the preceding embodiments, the actuating devices is configured to house electroactive composition.

In any of the preceding embodiments, the actuating devices is configured to apply direct pressure to the housed electroactive material.

In any of the preceding embodiments, the actuating device comprises at least one of a compressed air single acting or double acting cylinder.

In any of the preceding embodiments, a stepper motor is associated with the actuating device. The motor is coupled to a transmission and braking mechanism.

In any of the preceding embodiments, a shut-off valve is configured to stop the flow of electroactive material into the flow cell.

In any of the preceding embodiments, a weighting device is associated with the actuating device.

In any of the preceding embodiments, gravity is used to force a weighting device to manipulate the actuating device.

In any of the preceding embodiments, a pivot device is used to directionally control a gravitational force on a weighting device used to manipulate the actuating device.

In any of the preceding embodiments, an actuating device comprised of a cylinder has at least one of ball screw, gear rack, or roller screw movement.

It will be appreciated that the above-described features may be implemented in combination with each other.

### BRIEF DESCRIPTION OF THE DRAWINGS

The invention is described with reference to the following figures, which are provided for the purpose of illustration only, the full scope of the invention being set forth in the claims that follow.

FIG. 1 illustrates a conventional multi-cell reversible stack electrochemical cell;

FIG. 2 is an embodiment of a single flow cell stack system in accordance with an exemplary aspect of the invention;

FIG. 3 is an alternative embodiment of single flow cell stack system utilizing a plurality of motors to actuate pistons in accordance with an exemplary aspect of the invention;

FIG. 4 is an alternative embodiment of single flow cell stack system utilizing a double acting cylinder actuated by a motor;

FIG. 5 is an alternative embodiment of FIG. 4 utilizing shut-off valves;

FIG. 6 is an exemplary embodiment of multi stack flow cell system;

FIG. 7 is an exemplary gravity driven flow cell system;

FIGS. 8-10 are exploded views of single redox flow cells;

FIG. 11 is an exemplary embodiments of manufactured flow cell devices;

FIGS. 12 and 12a are an exemplary embodiment of a manufactured perpendicular flow cell configuration; and

FIGS. 13-15 are isometric views of a co-planar configured flow cell system.

### DETAILED DESCRIPTION OF EXEMPLARY, NON-LIMITING EMBODIMENTS OF THE INVENTION

Exemplary embodiments of the present invention provide a flow cell device that eliminates shunt current by using a plurality of actuating devices, each actuating device connected to an individual flow cell of a redox flow cell stack. The use of a plurality of actuating components provides an economic benefit of mass production of such components. One or more embodiments of the invention can also be used on any other suitable battery cells beyond those described herein.

An aspect of the flow cell system provides direct coupling of cathode and anode actuating devices to a multi-cell stack so that a fluid line connecting the flow cell with stored electroactive slurry is not necessary. The direct connection of actuating devices to the cell stack provides less fluid resistance than an indirect connection via round connection lines.

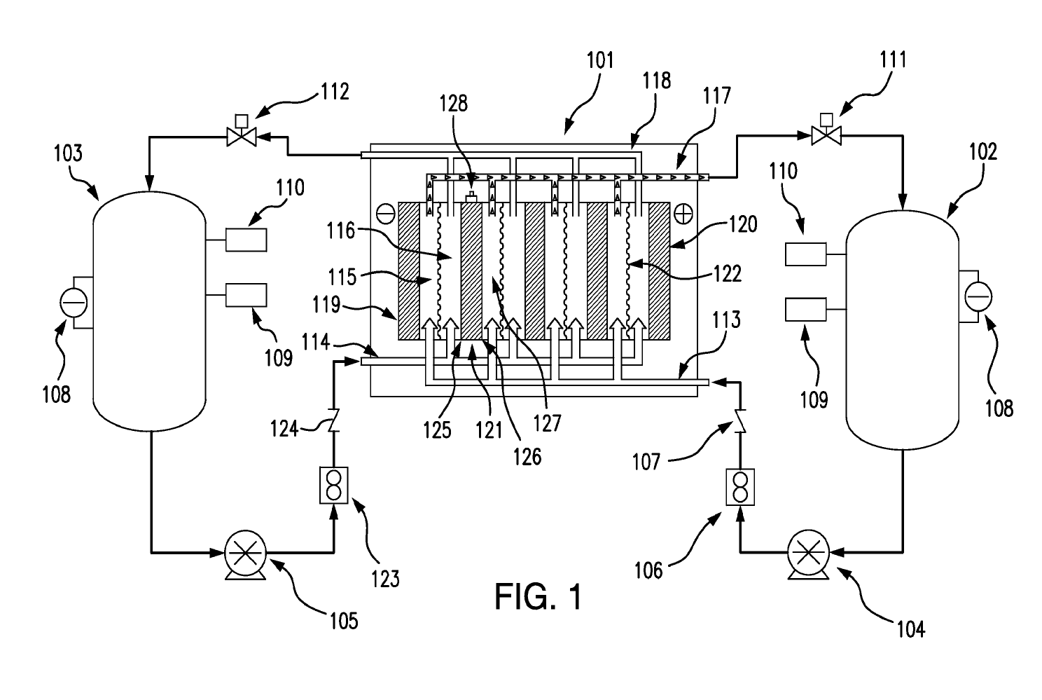

FIG. 1 illustrates a conventional semi-solid flow cell stack device 101. As shown in FIG. 1, the multi-cell stack device includes end electrodes 119 (anode) and 120 (cathode) at the end of the device, as well as one or more bipolar electrodes such as 121 (e.g., half the thickness is copper and half the thickness is aluminum). Between the electrodes, the multi-cell stack device also includes anode slurry compartments such as 115 and cathode slurry compartments such as 116. The two compartments are separated by ionically conductive membranes such as 122. This arrangement is repeated to include multiple cells in the device. Bipolar electrode 121 includes a cathode (cathode current collector) 125 which faces the cathode slurry cell compartment 116 and an anode (anode current collector) 126 which faces the anode slurry cell compartment 127. A heat sink or an insulator layer 128 is disposed in between cathode 125 and anode 126.

The multi-cell stack device is connected to an anode slurry storage tank 102 which stores the anode slurry. As shown in FIG. 1, a positive displacement pump 104 is used to pump anode slurry through a flow meter 106 and a check valve 107 into a manifold 113, which delivers the anode slurry into multiple anode slurry cell compartments such as 115. The positive displacement pump causes a fluid to move by trapping a fixed amount of it, and then forcing (displacing) that trapped volume through the pump and thereby advancing material into the manifold 113. As material enters into anode compartment 115, an equal volume of anode slurry is displaced (discharged) from the anode compartment. The discharged anode slurry is removed through manifold 117, flow valve 111 and back into the tank 102. Similarly, a positive displacement pump 105 is used to pump cathode slurry from storage tank 103, through a flow meter 123 and a check valve 124 into a manifold 114, which delivers the cathode slurry into cathode slurry cell compartments such as 116. The discharged cathode slurry is removed through manifold 118, flow valve 112 and back into the tank 103.

The manifold system described in FIG. 1 is referred to as an “open” manifold system because the manifold is open to or in flow communication with multiple electrode material compartments. The open manifold architecture can permit shunt currents to form between cells. To eliminate shunt current a plurality of actuating devices are employed, each actuating device connected to an individual flow cell of a redox flow cell stack. The actuating devices supply and remove slurry materials from the slurry compartments of the flow cell.

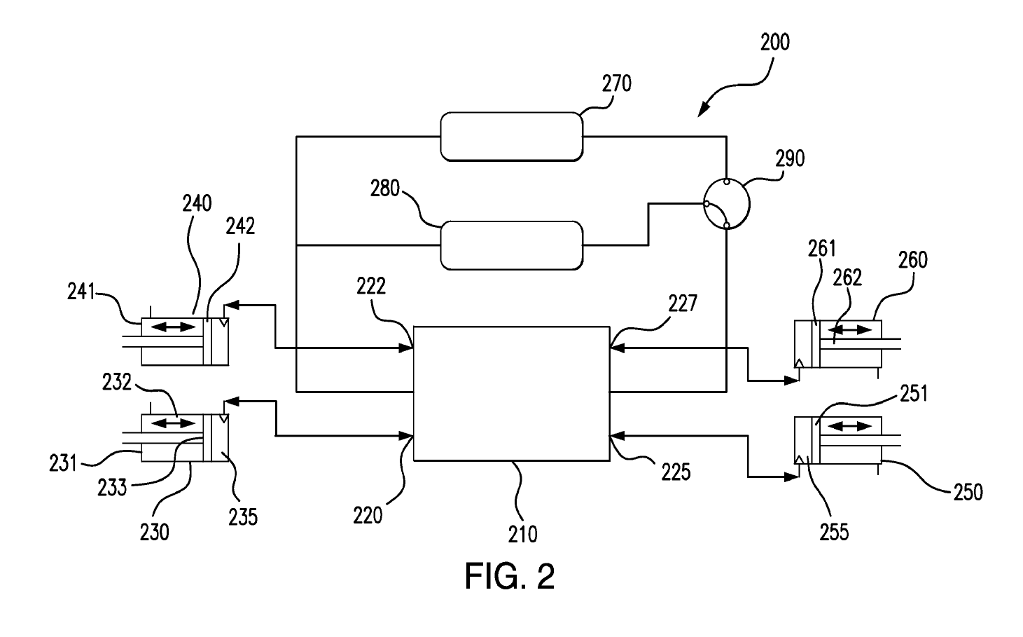

Features of a flow cell device in accordance with an exemplary embodiment are shown in FIG. 2. FIG. 2 illustrates flow cell system 200, having a single cell flow cell 210, although systems encompassing multiple cells can be envisioned. The flow cell 210 includes electrodes (anode and cathode) as well as anode slurry compartments and cathode slurry compartments (not shown in figure). The two compartments are separated by an ionically conductive membrane (also not shown). Actuating device 230 stores charged cathode slurry 235 until it is desired to introduce fresh, charged cathode material into the flow cell, for example, because a load 270 is placed upon cell 210 and energy is required. The actuating device typically includes a housing (231), such as a cylinder, for housing the electroactive slurry, and a piston (233) that sealingly contacts the walls of the housing to define a chamber that houses the electroactive slurry and that contacts the slurry (directly or indirectly) so as to apply a force on the slurry. Force is applied to the slurry by displacing the piston inwardly towards the slurry as indicated by arrow (232). Various external devices can be used to generate the force required to activate piston 233. For example, piston 233 can be moved by compressed air within actuating devices 230. A compressed air mechanism is coupled to device 230 that applies a pushing or pulling force to piston 233. Similarly, compressed air is used to manipulate pistons 242, 251, and 261 within devices 240, 250, and 260, respectively. As load 270 is applied, actuating device 230 pushes slurry 235 into cell 210 through inlet port 220. Introduction of slurry 235 into the flow cell results in the displacement of material that is currently contained within the flow cell cathode compartment. As material enters into cathode compartment, an equal volume of cathode slurry is displaced (discharged) from the cathode compartment. Simultaneously, cathode slurry within cell when a volume of new cathode material in introduced at inlet port 220, passes through outlet port 222 into a chamber for storing slurry in actuating device 240 by forcing piston 240 to retract. As described above for actuating device 230, actuating device 240 also includes a housing (241), such as a cylinder, for housing the electroactive slurry received from the flow cell, and a piston (242) that sealingly contacts the walls of the housing to define a chamber that houses the electroactive slurry and that contacts the slurry (directly or indirectly). The piston is displaced outwardly (away from the cell 210) with a rod that extends axially along the cylinder to enlarge the volume of the chamber so as to accommodate incoming cathode slurry. In some embodiments, piston movement occurs passively by pressure exerted on the piston by incoming cathode slurry. In other embodiments, the piston movement occurs actively, e.g., it may be powered to withdraw and thereby create a negative pressure in the cylinder to assist in the removal of slurry from the flow cell. Slurries are transferred into and out of cell 210 at the same rate. Accordingly, there is no pressure build up within cell 210 as a result of transfer of slurries with actuating devices 230, 240, 250 and 260. Actuating device 240 stores cathode slurry, for example, until cell 210 is depleted and requires recharging (or until some other appropriate time point).

The anode portion of cell 200 operates in a similar manner. For example, actuating device 250 stores charged anode slurry 255 until needed, e.g., a load 270 is placed upon cell 210 that requires additional energy. As load 270 is applied, actuating device 250 pushes charged slurry 255 into cell 210 across anode inlet port 225. Simultaneously, depleted anode slurry, e.g., anode slurry within cell when a new volume of anode slurry is introduced at inlet port 225, passes through anode outlet port 227 into a chamber for storing slurry in actuating device 260. Actuating device 240 stores anode slurry until cell 210 for a period of time, e.g., until the anode materials depleted and requires recharging or until some other appropriate time point). New anode and cathode electroactive slurry can be introduced into flow cell 210 when indicators show that the electroactive materials within the cell are depleted. Alternatively, new anode and cathode electroactive slurry can be introduced at regular intervals without regard to charge state of the cell or according to any schedule, as desired.

The transfer of electroactive material from the cathode and anode actuators can continue so long as charged material is available in the cathode and anode actuators. When slurries 235 and 255 have been completely transferred into cylinder housing 240 and 260 respectively (or at any other desired time), cell 210 can be recharged by reversing switch 290 to access power source 280. Power source 280 is used to recharge the depleted electroactive cathode and slurry materials in the same flow cell as was used to provide energy to an applied load. As a result of this process, actuator devices 240 and 260 operate to direct flow of depleted slurries that reside in devices 240 and 260 back into cell 210 where they are recharged. For example, force is applied to the depleted cathode slurry housed in the slurry chamber in actuator 240 by displacing the piston inwardly towards the cell 210. Actuating device 240 pushes slurry into cell 210 through outlet port 222, where it is recharged. A combined actuation of actuator 240 (which introduces a second volume of material from actuator 240 into cell 210) and actuator 230 (which withdraws a volume of material from cell 210 into the slurry chamber of actuator 230) effects the movement of the charged slurry back into actuator 230. Slurries are transferred into and out of cell 210 at the same rate. Accordingly, there is no pressure build up within cell 210 as a result of transfer of slurries with actuating devices 230, 240, 250 and 260.

Alternatively, the slurries can be recharged at different times. For example, it may be desirable to maintain approximately equal volumes of slurry material in each of the chambers located in cylinder housings 231 and 241. Thus, after a predetermined amount of material has transferred from, for example, the slurry chamber in cylinder housing 231 to the slurry chamber in housing 241, the process can be reversed and material is returned to the originating cylinder housing, along with the appropriate recharging of the depleted electroactive materials.

As shown in this embodiment, actuating devices 230, 240, 250 and 260 are single acting compressed air or pneumatic cylinders. As one of ordinary skill in the art would appreciate, the cylinders can be actuated by any means to move the piston so as to displace either anode or cathode slurry and transfer slurry into and through flow cell 210. For example, pistons may be actuated by electric motors or gravity acting on weights attached to the piston rods and then orienting the system accordingly. Furthermore, it is understood that actuators are not limited to a cylinder devices; however, any device could be used in order to achieve the effect of transferring cathode and anode slurry into and out of a flow cell at the same transfer rate.

The volume of fluid in a full cathode actuator is typically twice the cathode fluid volume in the cell, and similarly for the anode actuator. There is no fluid line or piping between the actuators and the stack, which means there is less fluid resistance and less cost for assembly and actuation. Prior art designs store cathode or anode slurries in single large tanks. The various fluid lines are expensive, and require pumps which have to have order of magnitude greater pressure than for the present invention.

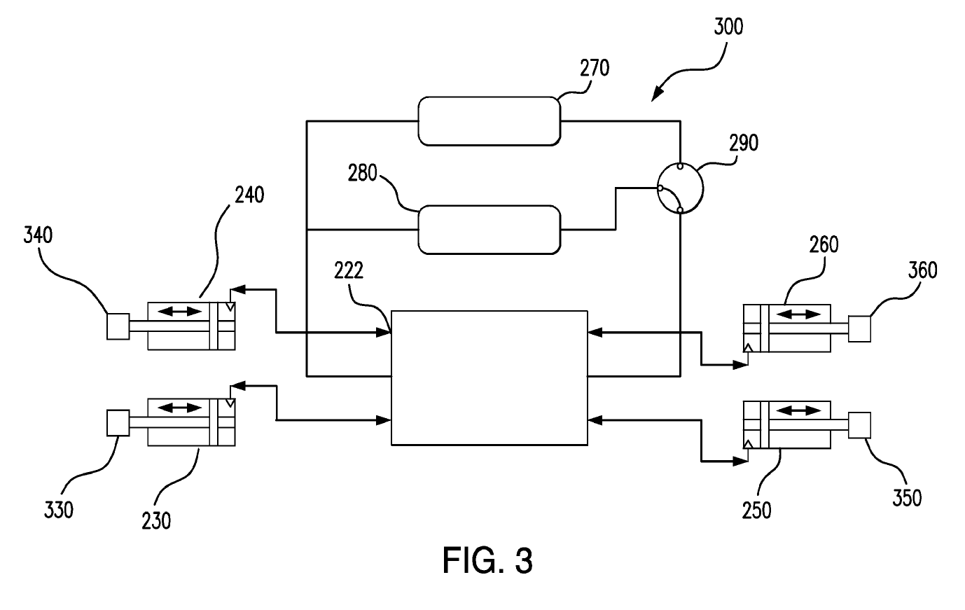

FIG. 3 is an alternative embodiment of the flow cell stack system shown in FIG. 2, in which previously identified elements are similarly labeled. Stepper motors are used to power the actuators and to move the internal piston back and forth on the internal rod axis. Stepper motors 330, 340, 350, and 360 provide power to actuators 230, 240, 250, and 260, respectively. This motion causes the actuating device to displace anode or cathode slurries inwardly or outwardly with respect to devices 230 and 240, and 250 and 260 in a manner similar to that previously described with regard to FIG. 2.

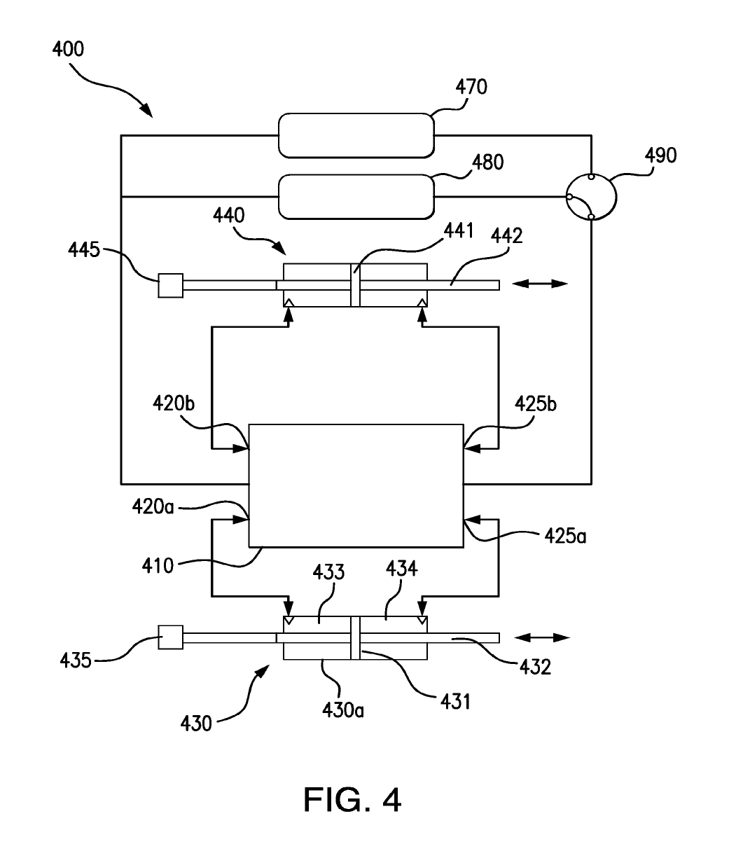

FIG. 4 shows a flow cell system 400, in which a single actuating device is used to house both charged and depleted electroactive slurries. Referring to actuator 430, the actuator includes a housing 430a such as a cylinder, for housing the electroactive cathode slurry, and a piston (431) that sealingly contacts the walls of the housing to define two chambers. A first chamber 434 houses a charged cathode slurry and a second chamber 433 houses the depleted electroactive slurry. Piston 431 is sealingly engaged with cylinder housing and forms two isolated compartments on opposite faces of cylinder 431. Piston 431 contacts both slurries so as to apply a force, for example, on slurry contained in chamber 433 by movement of the piston in the direction indicated by left hand movement of rod 432 and on the slurry contained in chamber 434 by movement of the piston in the right hand direction of rod 432.

During operation, drain on the flow cell charge state, for example due to application of load 470, necessitates replenishment of the electroactive material in cell 410. Charged cathode and anode slurries are displaced from actuating devices 430 and 440, respectively. Stepper motor 435 causes piston 431 and rod 432 to move in the left hand direction, which causes a volume of charged cathode slurry from chamber 433 to enter the flow cell through cathode inlet 420a. As charged slurry 433 enters cell 410, used or depleted cathode slurry passes through cathode outlet 425a and enters chamber 434 of actuating device. Depleted cathode slurry is stored until the power source 480 causes switch 490 to reverse and recharge process is commenced. A similar operation occurs with respect to anode components 440 and 445. Notably, actuating devices 430 and 440 comprise double rods 432 and 442, respectively. The double rods provide for equal volumes on either side of pistons 431 and 441 as pistons are actuated. As the volume in chamber 433 decreases to inject a volume of slurry from chamber 433, chamber 434 increases by the same volume and is able to accommodate a volume of slurry ejected from cell 410. Accordingly, there is no pressure build up within cell 410 as a result of transfer of slurries with actuating devices 430 and 440.

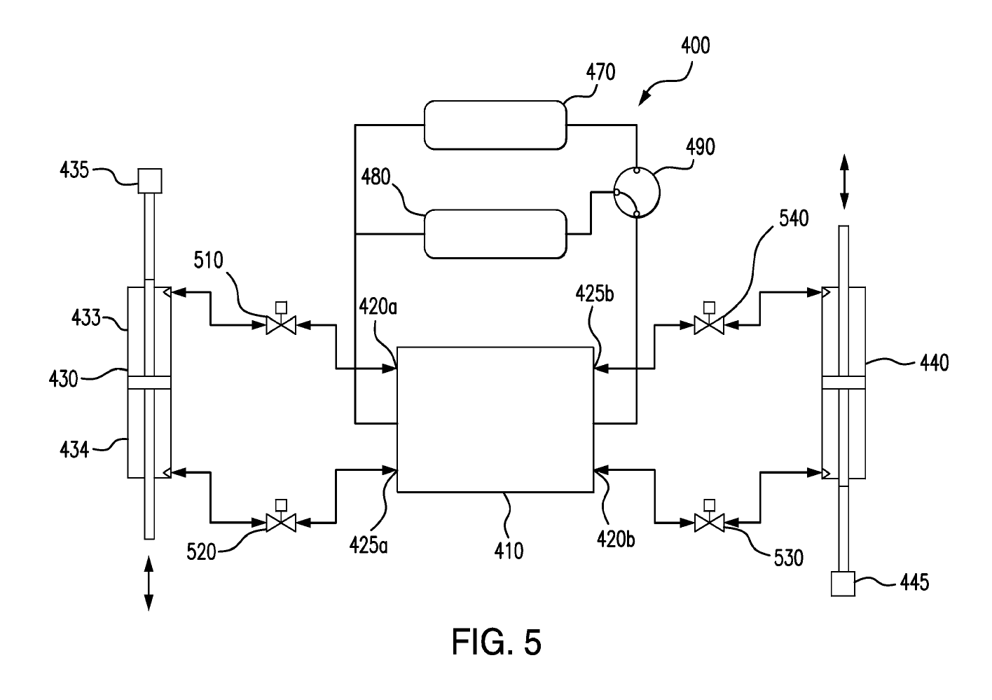

FIG. 5 is an alternative embodiment to FIG. 4. In addition to all elements disclosed in FIG. 4, shut-off valves 510, 520, 530, and 540 are used to control the inward and outward flow of electrode slurries with respect to actuating devices 430 and 440. One of ordinary skill in the art would appreciate that flow cells discharge over time. The use of shut-off valves previous flow into or out of cell 410 and thus prevents leakage of cathode and anode material from system 400. Furthermore, valves 510, 520, 530, and 540 provide for accurate measurement of slurry material entering cell 410.

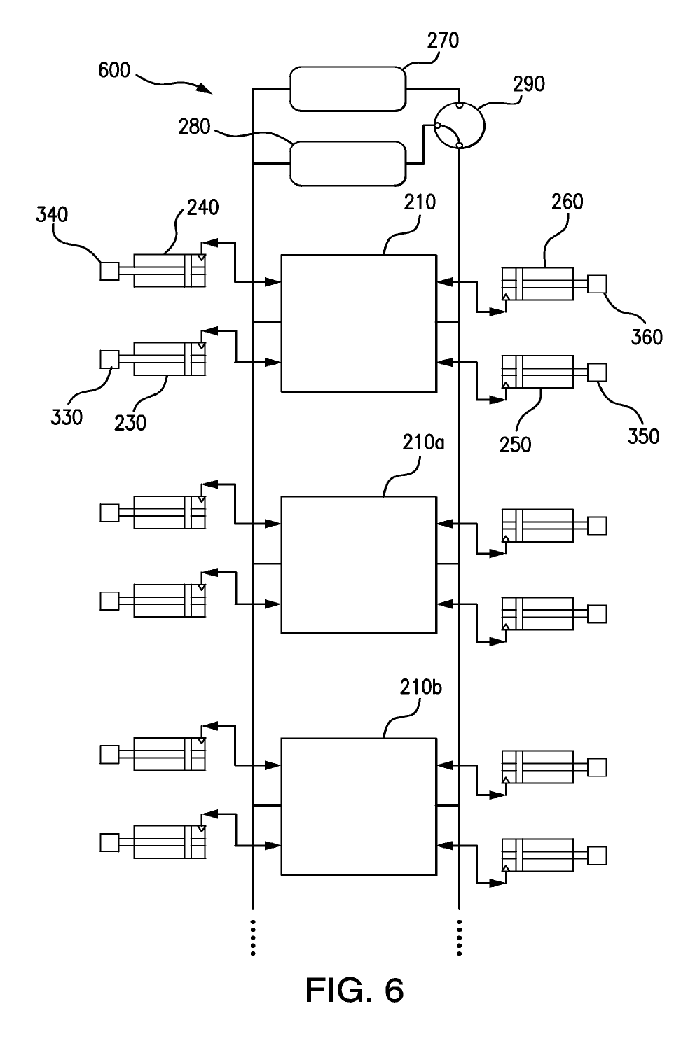

FIG. 6 is an alternative embodiment to that shown in FIG. 3 illustrating a multicell flow cell system 600. In this embodiment, three single cell flow cells are electrically connected. Similar to FIG. 3, electrode slurry material is displaced within flow cell 210 by use of actuating devices such as 230, 240, 250 and 260. Stepper motors are used to actuate pistons using the rods of the actuating devices. The same configuration is repeated for cells 210a and 210b. Flow cells 210, 210a, and 210b are configured to have an independent pair of actuating devices, e.g., at least one device for displacing a cathode slurry and at least one device for displacing an anode slurry, in communication with each cell. Thus, there is no flow communication between the individual cells. This configuration prevents or mitigates shunt current between the cells.

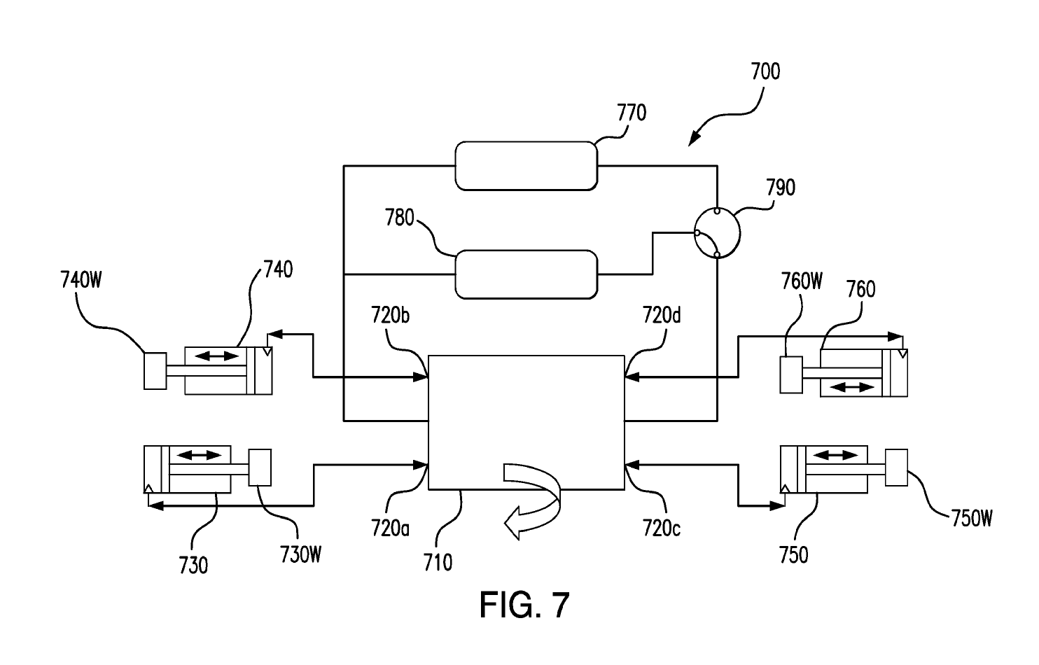

FIG. 7 shows flow cell system 700 according to an exemplary embodiment of the present invention. In this embodiment, charged cathode and anode slurry material from actuating devices 730 and 750, respectively, are introduced into cell 710 through inlet ports 720a and 720c. Used or depleted cathode and anode material are respectively exit from cell 710 into actuating devices 740 and 760. Similar to the inward flow of slurry into cell 710, depleted slurry material passes through the cell into actuating devices 740 and 760 at specific location, e.g., 720b and 720d.

Gravity aligned with the arrows in the cylinders provides the force required to move slurry material into and out of cell 710. In a first arrangement, weights 730W and 750W are positioned above the charged cathode and anode slurry material, so that weights 730W and 750W exert pressure sufficient to push charged electrode slurry material from actuators 730 and 750 into cell 710. For example, in a first position as indicated in FIG. 7, weights 730W and 750W apply force to actuating devices 730 and 750 to push cathode and anode fluids, respectively into cell 710. Gravitational forces act on weights 740W and 760W to pull the cylinders away from the slurry and create a negative pressure that assists in the removal of electroactive slurry from cell 710. Furthermore, system 700 includes a device (not shown) that allows the entire assembly to rotate 180° to alter the forces applied by the weights to the actuating devices and the slurries contained therein. In a second position, the entire assembly is rotated 180° around an axis indicated by arrow 777, and the gravitational forces are reversed. Accordingly, gravitational forces act on weights 740W and 760W, which applies a force to actuating devices 740 and 760, thereby pushing depleted electrode material from actuators 740 and 760 to reenter cell 710. Gravity acting on weights 730W and 750W to pull the cylinders away from the slurry and create a negative pressure that assists in the removal of electroactive slurry from cell 710.

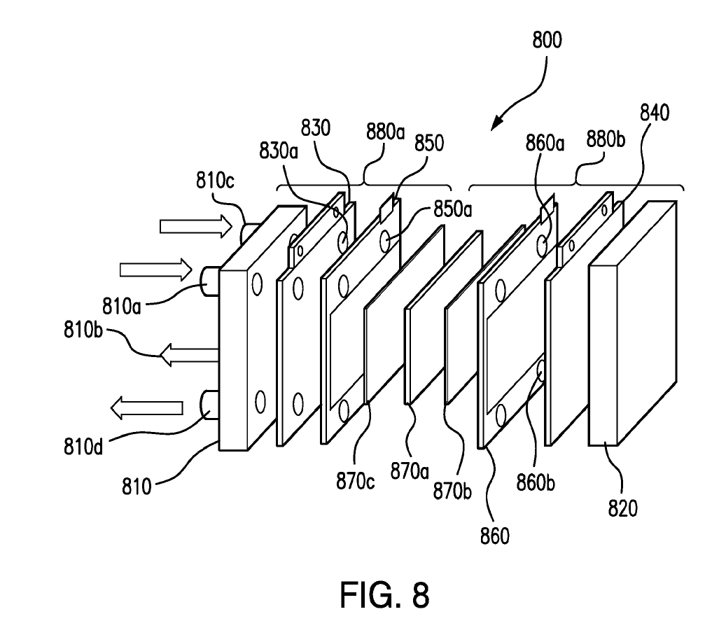

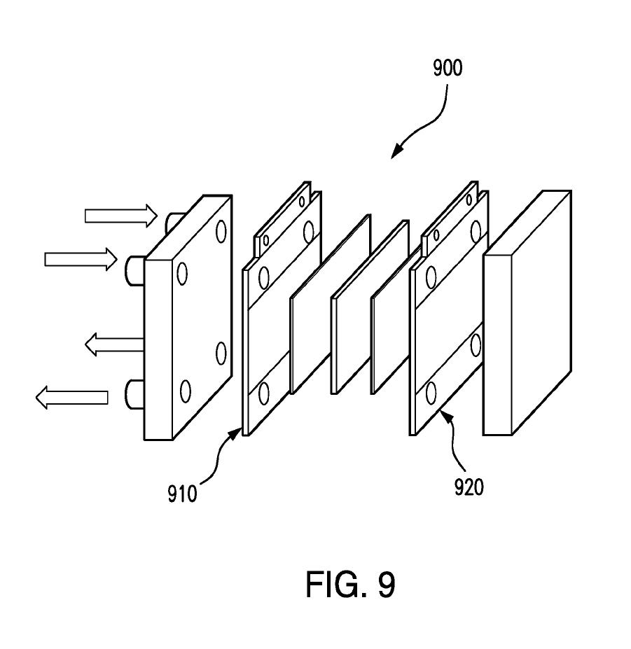

FIGS. 8, 9, and 10 are exploded views of a stack design used in a redox flow cell or fuel cell according to one or more embodiments. FIG. 8 depicts an exploded view of a design for a single redox flow cell. Flow cell system 800 comprises end plates 810 and 820, which serve to secure all the components and provide sealing integrity to the overall stack. Current collectors 830 and 840 collect and concentrate the current from the active area of the flow cell and transfer to a specific location within the cell. The concentrated current can be transferred to the load via electrical conductors (not shown). Insulation plates or gaskets (not shown) may be used to isolate the end plates from the current collectors. Cathode plate 860 and anode plate 850 are placed against current collectors 840 and 830, respectively, to distribute the electrode slurry flow evenly across membrane/separator 870a such that an electrochemical reaction occurs. Cathode and anode plates 860 and 850 are separated by the on exchange membrane 870a, which defines a cathode active area 880b and anode active area 880a on either side separator 870a. The active areas inside the flow plates may include a support structure, e.g., mesh to increase conductivity or increase turbulence or provide additional support to membrane/separator. The overall structure is commonly clamped by using long rods (not shown) to bolt all components together. The applied compression gives proper sealing to all passages and active areas of the flow cell.

Cathode slurry can enter system 800 via port 810a. Depleted cathode slurry exits system 800 via port 810b. It should be appreciated that there are corresponding openings in current collector 830 (opening 830a), anode plate 850 (opening 850a) that provide a conduit for cathode material to cathode plate 860 via opening 860a. Depleted cathode slurry is passed out of cell 800 from cathode plate opening 860b through openings (not shown) in the anode plate 850 and current collector 830. Cathode slurry exits cell 800 via port 810b. Anode slurry material passes through cell 800 in a similar fashion via ports 810c and 810d. One of ordinary skill in the art would appreciate that electrode slurry material can flow through cell 800 in a counter flow or co-flow configuration.

FIG. 9 is an exploded view of an alternative embodiment of the flow cell shown in FIG. 8, in which similar elements are similarly labeled. In this embodiment, anode and cathode components are combined with a current collector into individual plates 910 and 920, respectively. The combined plates provide simplified assembly construction and reduce overall cost.

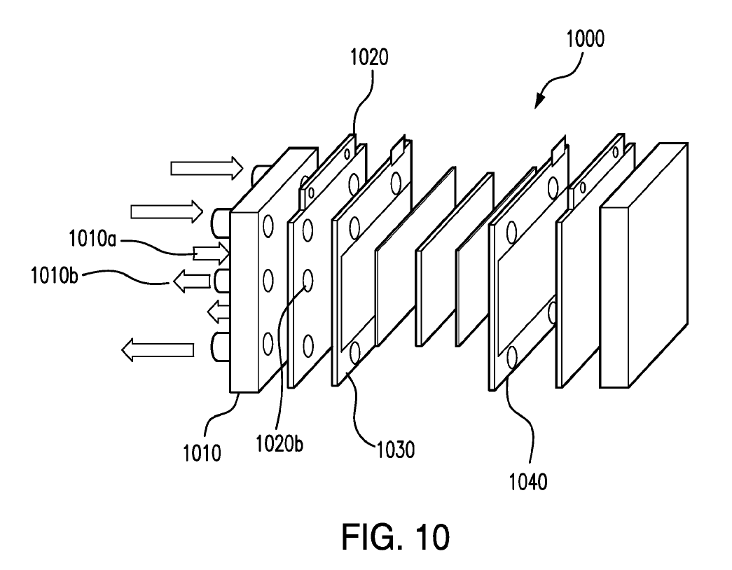

FIG. 10 is also an alternative embodiment of FIG. 8 that provide enables temperature control in the flow cell. Coolant ports 1010a and 1010b are integrated into end plate 1010 and allow coolant to be transported throughout cell 1000. Current collector has an opening 1020b corresponding to port 1010b, which allows coolant to pass through cell 1000 out of port 1010b. There is also a corresponding opening (not shown) in current collecting plate 1020 for the delivery of coolant from port 1010a. The delivery of coolant to cell 1000 allows for the transport of heat out of the cell, which maintains an even temperature distribution throughout the flow cell. Cooling channels are located on the opposite side of the anode and cathode plates 1030 and 1040, respectively. The distribution of coolant allows electrode slurries to be cooled within cell 1000.

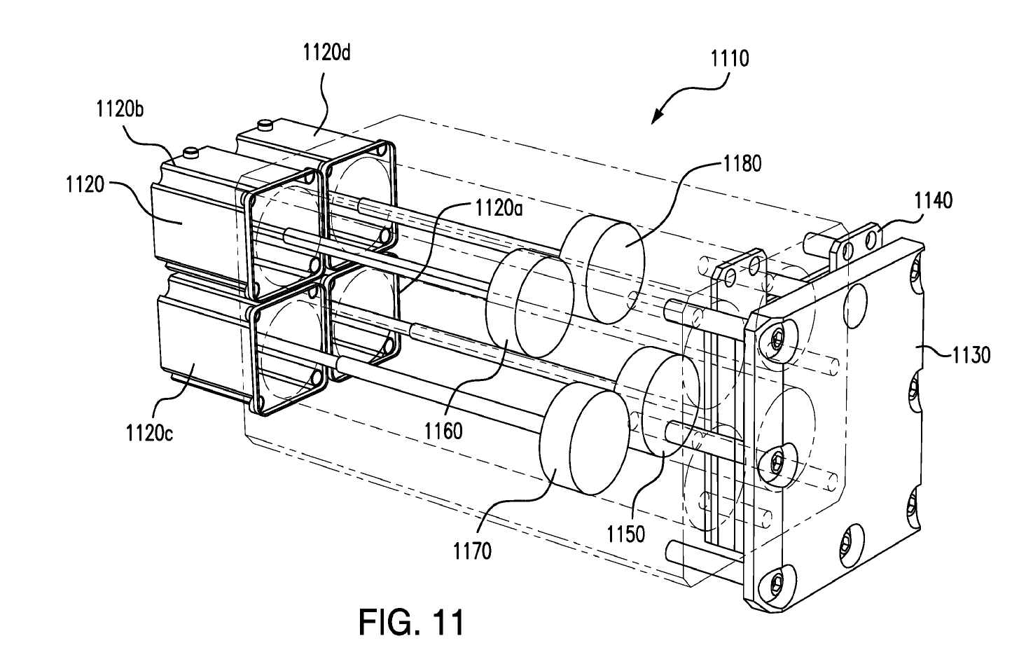

FIG. 11 shows an assembled flow cell stack system according to exemplary embodiments of the present invention. Flow cell stack system 1100 comprises main body 1110, stepper motors 1120, and flow cell 1130. Actuator device 1150, which is powered by motor 1120a, pushes charged cathode slurry into cell 1130 (walls to system 100 have been removed for illustration purposes). Motors 1120b, 1120c, and 1120d operates similar to motor 1120a. Depleted cathode slurry material is pulled from cell 1130 into actuator device 1160. Anode slurry is displaced within cell 1130 according to the same process, with actuating device 1170 introducing anode slurry into cell 1130 and actuating device 1180 removing anode slurry from cell 1130. Gasket 1140 is situated between actuating devices 1150, 1160, 1170, and 1180 and cell 1130 in order to prevent leakage of electrode material from cell.

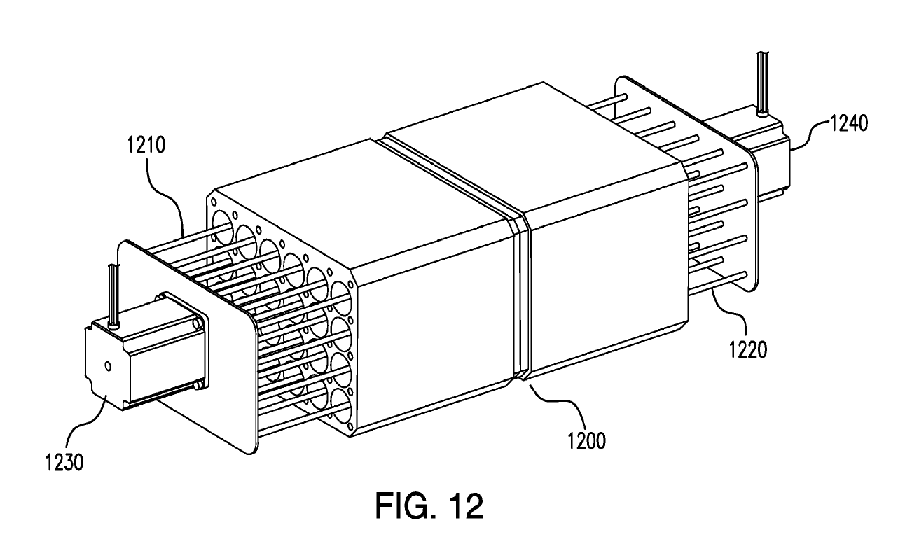

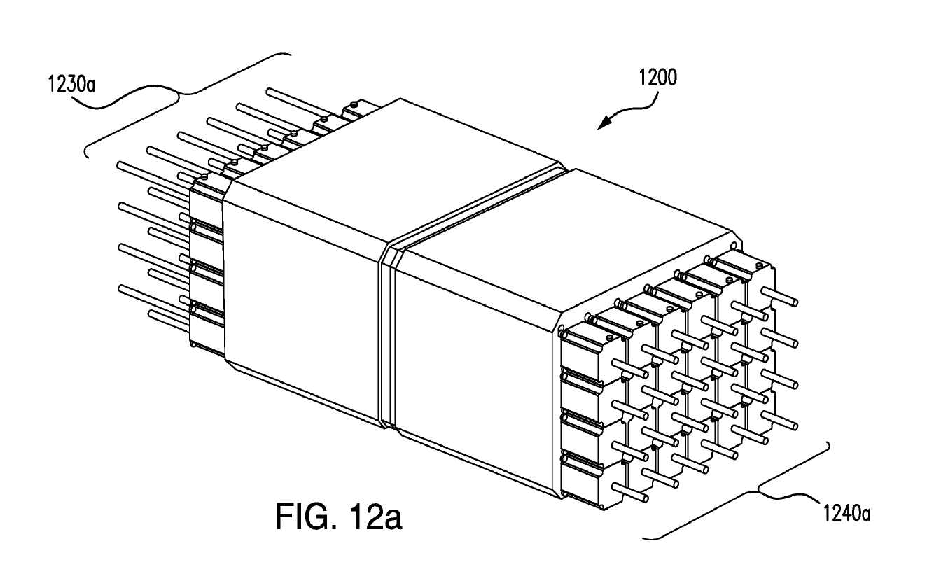

FIGS. 12 and 12a show alternative embodiments of a multi cell stack flow cell system 1200. In this system, a plurality of flow cells are perpendicularly configured with respect to inlet and outlet cathode and anode actuating devices 1210 and 1220, respectively. Similar to other embodiments of the present invention, each flow cell is associated with a pair of cathode actuating devices and a pair of anode actuating devices, wherein electroactive slurry is displaced within the associated flow cell. FIG. 12 shows an embodiment wherein a single stepper motor 1230 powers the bank of inlet actuating devices 1210 and a single stepper motor 1240 powers the bank of outlet devices 1230. FIG. 12a is a similar embodiment; however each inlet actuating device is powered by an individual stepper motor, as shown in 1230a. Each outlet actuating device is powered by an individual stepper motor, as shown in 1240a. This configuration allows for better control of cell 1200, as an individual motor may malfunction without preventing operation of cell 1200.

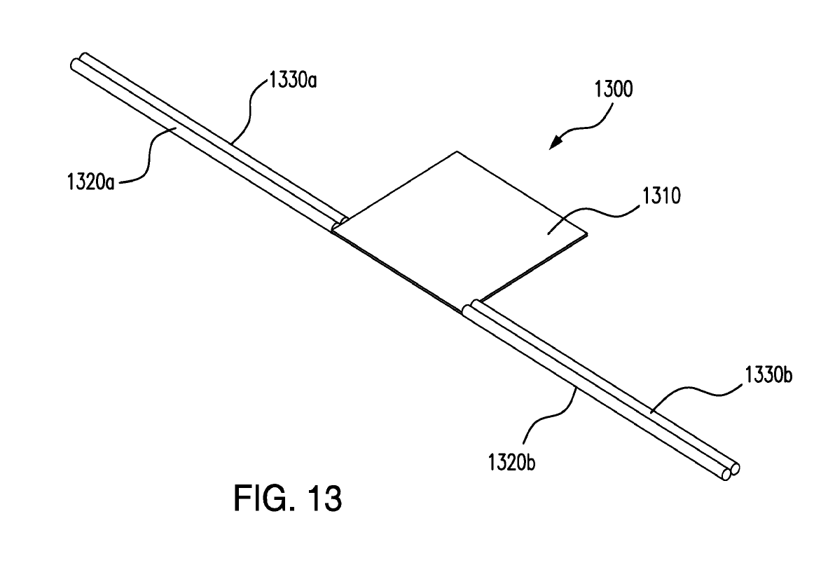

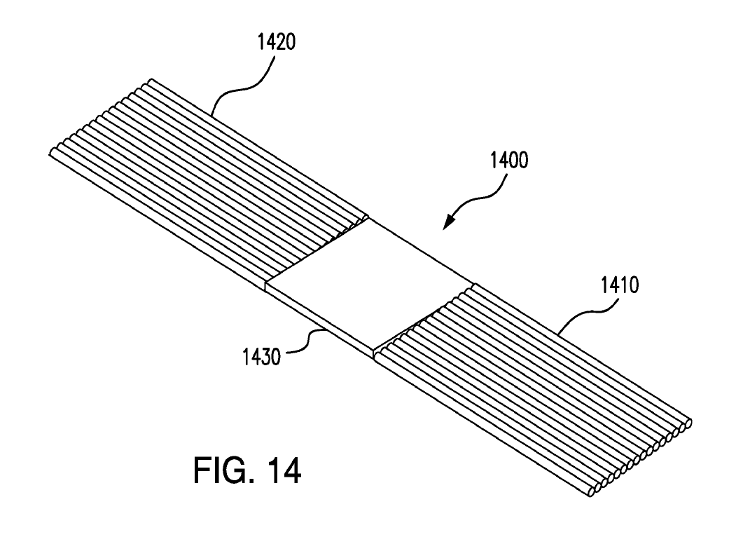

FIGS. 13 and 14 are isometric views of a multi stack flow cell system 1300. System 1300 shows a flow cell 1310 configured in a co-planar fashion with respect actuating devices 1320a, 1320b, 1330a, and 1330b. For example, device 1320a contains charged cathode slurry that is pushed into cell 1310. Device 1320b is used to pull and store depleted cathode slurry from cell 1310. A similar process occurs with anode slurry, which is moved via devices 1330a and 1330b.

FIG. 14 shows a constructed system 1400 in a co-planar configuration. As shown, system 1400 comprises a plurality or stack of cells connected with a plurality of actuating devices 1410 and 1420. The devices are offset by twice the sum of their diameters. Actuators 1410 and 1420 are shown in a diagonal configuration with respect to stack 1430 as a pair of actuators is used for each type of electrode fluid per individual cell. This configuration provides that the minimum stack width in order to form a group, where multiple groups can then be slacked upon each other so that the cylinders nest for tight packing and hence high space efficiency. A typical stack width will be about fifteen to twenty times the actuators outer diameter.

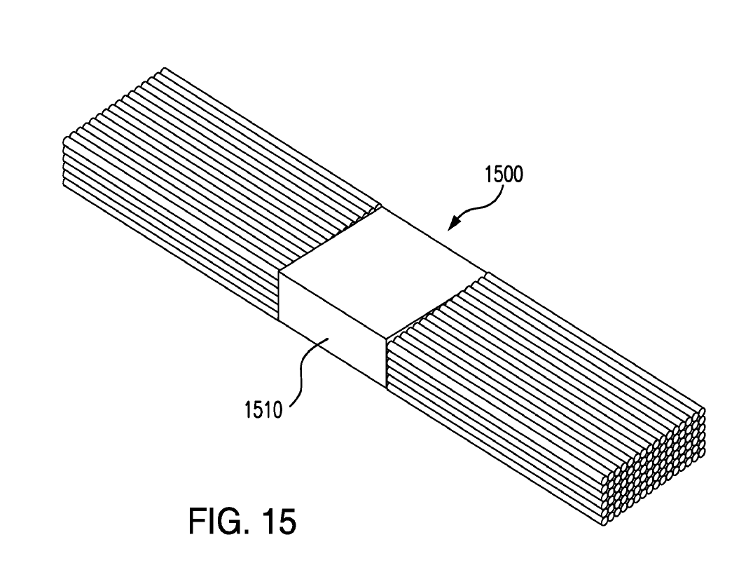

Similar to FIGS. 13 and 14, FIG. 15 shows a co-planar configuration of a multi-stack flow cell system. Pluralities of flow cell systems 1510 are serially stacked together to form an energy storage device. This allows the voltage of each cell to be added to provide high voltage output without creating shunt current. Table 1 details specifications for the multi-stack flow cell system shown in FIG. 15.

TABLE 1

| | | |
|---|---|---|
| fluid viscosity, nu (N-s/m\hat{ }2) | 2 | |
| Plates | | |
| plate pitch (mm) | 3 | |
| width/length ratio | 1 | |
| height, h (m, mm) | 0.001 | 1 |
| width, w (m, mm) | 0.364 | 364 |
| length, L (m, mm) | 0.364 | 364 |
| flow velocity, V (m/s, microns/sec) | 0.0002 | 200 |
| flow, q (m\hat{ }3/s) | 7.28E−08 | |
| pressure, P (N/m\hat{ }2, psi) | 1747 | 0.253 |
| cylinder bore diameter, Dp (mm) | 20 | |
| axial force, F (N, lb) | 0.549 | 0.123 |
| Cylinders | | |
| cylinder wall thickness (mm) | 1.25 | |
| cylinder outside diameter (mm) | 22.5 | |
| spacing between cylinders' out diameters (mm) | 0.25 | |
| cylinder pitch (mm) | 22.75 | |
| Pitch between pairs of anode/cathode cylinders | 45.5 | |
| (mm) | | |
| Length of cylinder/length of stack plate | 2 | |
| length of cylinder (m, mm) | 0.728 | 728 |
| cross sectional area of cylinder bore (m\hat{ }2) | 0.00031 | |
| Unit volumes | | |
| volume in anode or cathode passage in a plate) | 0.00013 | 0.132 |
| (m\hat{ }3, liters | | |
| volume of each cylinder (m\hat{ }3, liters) | 0.00023 | 0.229 |
| volume of plate/volume cylinder | 0.579 | |
| Groups | | |
| number of plates and cylinders required in | 8 | |
| same group to enable nesting of groups | | |
| System | | |
| Number of nested groups desired | 10 | |
| number of plates in stack | 80 | |
| total volume of fluid in cathode cylinder (liters) | 18.3 | |
| total length (mm, m) | 1820 | 1.82 |
| total height (mm, m) | 262.5 | 0.2625 |
| total width (mm, m) | 364.0 | 0.364 |
| total system volume (liters) | 174 | |
| total volume of anode or cathode fluid (liters) | 18.3 | |
| total volume anode + cathode (liters) | 36.6 | |
| fluid volume/total system volume | 21.0% | |
| if used square pistons | 26.8% | |

The above-described features may be implemented in combination with each other to provide various exemplary embodiments in accordance with the invention.

Although the invention has been described and illustrated in the foregoing illustrative embodiments, it is understood that the present disclosure has been made only by way of example, and that numerous changes in the details of implementation of the invention can be made without departing from the spirit and scope of the invention, which is limited only by the claims that follow. Features of the disclosed embodiments can be combined and rearranged in various ways within the scope and spirit of the invention.

1. A flow cell energy storage system comprising:
(a). a flow cell comprising a cathode current collector, an anode current collector, and an ion-permeable membrane arranged to define a positive electroactive zone and a negative electroactive zone; and
(b). a plurality of actuating devices comprising:
i. a first actuating device configured to introduce an electroactive composition, directly or indirectly, between the cathode current collector and the ion-permeable membrane,
ii. a second actuating device configured to remove an electroactive composition, directly or indirectly, from said one of the positive or negative electroactive zones,
iii. a third actuating device configured to remove an electroactive composition, directly or indirectly, from said one of the positive or negative electroactive zones; and
iv. a fourth actuating device configured to remove an electroactive composition, directly or indirectly, from said one of the positive or negative electroactive zones;
wherein the first and second actuating devices are operatively arranged to coordinate the introduction of the electroactive compositions and the removal of the electroactive compositions by the third and fourth actuating device.
wherein the first and second actuating devices are operatively arranged to coordinate the introduction of an electroactive composition by the first actuating device and the removal of an electroactive composition by the second actuating device.

2. The flow cell system of claim 1, wherein the actuating devices comprises an electroactive composition housing chamber.

3. The flow cell of claim 2, wherein the first actuator is configured to displace the actuator from a first resting position to a second actuated position, wherein the actuated position advances a pressure bearing member into the electroactive composition housing chamber.

4. The flow cell of claim 1, wherein the third actuator is configured to displace the actuator from a first resting position to a second actuated position, wherein the actuated position withdraws a pressure bearing member away from the electroactive composition housing chamber.

5. The flow cell of claim 1, wherein the first and third actuating devices are integrated into a single double action actuation device comprising:
a housing; and
a pressure bearing member in sealing contact with the walls of the housing and positionable within the housing to define first and second electroactive composition housing chambers,
wherein the first electroactive composition housing chamber is operatively connected to introduce an electroactive composition into the flow cell, and
wherein the second electroactive composition housing chamber is operatively connected to remove an electroactive composition from the flow cell.

6. The flow cell of claim 5, wherein the second and fourth actuating devices are integrated into a single double action actuation device comprising:
a housing; and
a pressure bearing member in sealing contact with the walls of the housing and positionable within the housing to define third and fourth electroactive composition housing chambers,
wherein the third electroactive composition housing chamber is operatively connected to introduce an electroactive composition into the flow cell, and
wherein the fourth electroactive composition housing chamber is operatively connected to remove an electroactive composition from the flow cell.

7. The flow cell system of claim 1, wherein the actuating device comprises a pneumatic cylinder, wherein the cylinder is configured to house at least one of charged and depleted electroactive material.

8. The flow cell system of claim 1, wherein the first and third actuating devices further comprises a stepper motor.

9. The flow cell system of claim 2, wherein the each of the first and third actuating devices further comprises a weight configured to advance or withdraw a pressure bearing member with respect to the electroactive composition housing chamber.

10. The flow cell system of claim 9, further comprising a pivot assembly configured to rotate the flow cell system such that gravity causes the weighting devices to simultaneous transfer in charged electroactive composition to the flow cell and remove depleted electroactive composition from the flow cell.

11. The flow cell system of claim 1, wherein the actuating device comprises an actuation member selected from the group consisting of ball screw, worm gear rack and roller screw and combinations thereof.

12. The flow cell system of claim 1, further comprising at least one shut-off valve configured to stop at least one of the inward or outward flow of electroactive composition in relation to the flow cell.

13. The flow cell system of claim 12, wherein at least one shut-off valve associated with inward flow of electrode reactant and at least one shut-off valve associated with the outward flow of electrode reactant, is configured to stop flow in a coordinated fashion.

14. The flow cell system of claim 1, wherein the actuator is directly coupled with the flow cell.

15. The flow cell system of claim 3, wherein the actuating devices are configured to apply a pressure of 150 psi to the cylinder.

16. A method of manufacturing a flow cell, comprising:
providing a plurality of flow cells according to claim 1; and
stacking the plurality of flow cells in series such that the voltages are added without a shunt current between the flow cells.

17. The method of claim 16, further comprising stacking the plurality of flow cells in a perpendicular manner.

18. The method of claim 16, further comprising stacking the plurality of flow cells in a co-planar manner.

19. A method of operating a flow cell, comprising:
a. providing at least one flow cells according to claim 1, wherein the first actuating device houses a first electroactive slurry;
b. introducing a volume of the first electroactive slurry to the flow cell through an inlet port connected with the first actuating device, wherein the introduction occurs as a result of a force exerted on the first electroactive slurry from a first actuating device;
c. removing a volume of a second electroactive slurry from the flow cell through an outlet port connected with the third actuating device, wherein the removal occurs as a result of a force on the second electroactive slurry from a third actuating device; and further wherein the actuating devices are configured to transfer charged electrode reactant into the flow cell at the same rate as depleted electrode reactant is transferred out of the flow cell;
d. wherein the first and third actuating devices coordinate the introduction of the first electroactive slurry by the first actuating device and the removal of the second electroactive slurry the third actuating device.

20. The method of claim 19, wherein the transfer of charged electrode reactant into the at least one flow cell results in the displacement of depleted electrode reactant in the at least one flow cell.

21. The method of claim 20, wherein the actuating devices are configured to add the first electroactive slurry to the flow cell and remove the second electroactive slurry from the flow cell at the same rate.

22. The method of claim 19, wherein the electroactive slurry is at least one of an anode or cathode slurry.

23. The method of claim 19, wherein the force exerted on the charged and depleted electrode reactant is at least one of positive or negative pressure.

24. The method of claim 23, wherein the pressure is in the range of one to twenty atmospheres.

25. The method of claim 19, wherein the actuating device comprises a weight configured to advance or withdraw a pressure bearing member with respect to the electroactive composition housing chamber, such that gravity is allowed to create a force sufficient to introduce the volume of the first electroactive slurry into the flow cell and remove the volume of the second electroactive slurry from the flow cell.

26. The method of claim 25, further comprising:
rotating the flow cell system about a central axis to orient the system in a first orientation that provides a force sufficient to introduce the volume of the first electroactive slurry into the flow cell; and
rotating the flow cell system about an central axis to orient the system in a second orientation that provides a force sufficient to remove the volume of the second electroactive slurry into the flow cell.

27. The method of claim 26, wherein the actuating device comprises an electric motor to operate the plurality of actuating devices.

28. The method of claim 26, wherein the actuating device comprises a stepper motor to operate the plurality of actuating devices.

29. The method of claim 26, wherein the electric motor is coupled to a worm gear transmission such that the system is to be oriented at an angle and be held in place when the motor is shut off.

30. The method of claim 26, wherein the electric motor is coupled to a transmission and an electric brake to allow the system to be oriented at an angle when the current to the motor is shut off.
